(19) United States
(12) Patent Application Publication
(10) Pub. No.: US 2025/0192636 A1
(43) Pub. Date: Jun. 12, 2025

(54) A BOBBIN

(71) Applicant: PROTEAN ELECTRIC LIMITED, FARNHAM, SURREY (GB)

(72) Inventors: Chengwei GAN, Farnham, Surry (GB); Jonathan LEA, Farnham, Surry (GB); Simon BROCKWAY, Farnham, Surry (GB)

(21) Appl. No.: 18/845,511

(22) PCT Filed: Feb. 21, 2023
(86) PCT No.: PCT/GB2023/050382

§ 371 Date: Sep. 10, 2024

(30) Foreign Application Priority Data
Mar. 10, 2022 (GB) 2203321.1

(51) Int. Cl. H02K 3/52; H02K 15/121

(52) U.S. Cl. CPC H02K 3/522; H02K 3/527; H02K 15/121; H02K 2203/12

(57) ABSTRACT

A bobbin for a stator or rotor of an electric motor, the bobbin comprising an injection moulded plastic housing having a first section and a second section, wherein the first section is arranged to receive coil windings and includes an aperture to allow a tooth mounted on the stator or rotor to extend through the aperture, wherein the second section includes a flange arranged to extend in a first direction substantially orthogonal to the aperture that acts as a tooth tip for the tooth, wherein a metal element is mounted in or on the flange.

### RELATED APPLICATION

This application is based on prior filed copending International Application No. PCT/GB2023/050382 filed Feb. 21, 2023, which claims priority to Great Britain Application No. 2203321.1, filed Mar. 10, 2022, the entire subject matter of these applications is incorporated herein by reference in its entirety.

### TECHNICAL FIELD

The present invention relates to a bobbin, in particular a bobbin for a stator or rotor of an electric motor.

### BACKGROUND

Stators are well known as the stationary part of an electric motor or electric generator relative to which a rotor turns.

Stators generally comprise a magnetic component and other structural components. Electric motors work on the principle that a current carrying wire will experience a force in the presence of a magnetic field. Typically, a rotor, carrying a set of permanent magnets, is arranged to rotate about a set of coils that are arranged to carry an electric current, resulting in the rotor rotating about the stator and generating movement. It will be appreciated that it is also possible for the rotor to carry a set of coils and the stator to carry a set of permanent magnets.

An example of a stator, which is arranged to be mounted within a rotor, is shown in FIG. 1. FIG. 1 shows the back-iron of a stator formed of a single piece of material, for example from PM (powder metal) or more commonly built up of a number of identical laminations. The protrusions 100 from the circular support 150 (also known as a back iron or back ring) are known as “teeth” and are used to receive a plurality of coil windings. To increase performance of a motor it is desirable to optimise the total cross-section of the coil windings, which would have the effect of reducing resistance, thereby reducing heat generation. Additionally, with the coil windings being in closer proximity, this would have the effect of improving thermal conductivity, which would have the effect of increasing motor efficiency with improving continuous performance.

However, with an arrangement such as that shown in FIG. 1, where the entire stator is formed of a single solid piece, it will be appreciated that there is a limited amount of space to physically wind the wire coils about the teeth.

Therefore, it is common in such arrangements for there to be gaps between the coils of adjacent teeth, which is inefficient since this space could otherwise be filled with wire coils to increase the total cross-section of the coil windings.

Further, large single piece stators typically require complex winding machines and complex winding processes to perform the required coil windings.

It is desirable to improve this situation.

### SUMMARY

In accordance with an aspect of the present invention there is provided a bobbin, stator, rotor or method according to the accompanying claims.

The invention provides the advantage of allowing coil winding to be individually wound on a bobbin prior to being mounted to the stator back-iron, thereby allowing the space between coils on adjacent stator teeth to be minimised while allowing an integrated tooth tip within the bobbin to reduce proximity losses generated in the coil windings as they pass magnets and torque ripple and cogging effects within an electric motor. The use of tooth tips integrated within the bobbin also provides the advantage of reducing the risk of permanent magnets becoming demagnetised by shielding the magnets from flux generated by the coil windings.

### BRIEF DESCRIPTION OF THE DRAWINGS

The present invention will now be described, by way of example, with reference to the accompanying drawings, in which:

FIG. 1 illustrates a prior art example of a stator formed as a single piece with integral teeth;

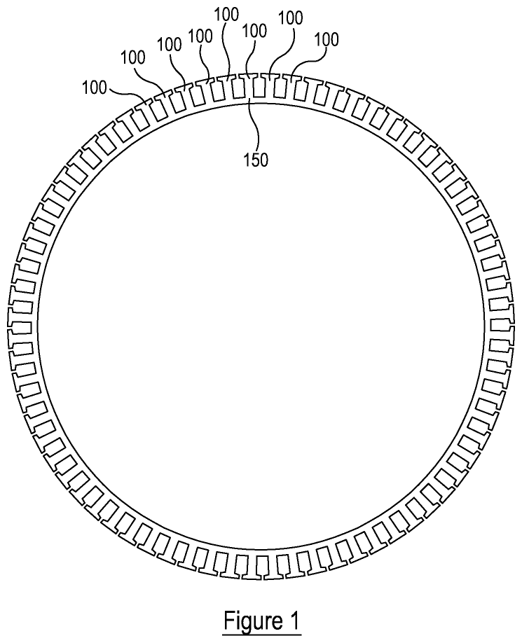

FIG. 2 illustrates a stator according to an embodiment of the present invention;

FIG. 3 illustrates a perspective view of a bobbin according to an embodiment of the present invention;

FIG. 4 illustrates a transparent perspective view of a bobbin according to an embodiment of the present invention;

FIG. 5 illustrate tooth tip dimensions according to an embodiment of the present invention;

FIG. 6 illustrates a drive cycle consumption table;

FIG. 7 illustrates a cogging torque results table.

### DETAILED DESCRIPTION

Although embodiments of the invention will now be described in relation to a stator for an electric motor, it should be appreciated that the invention applies equally to rotor arrangements in the instance of electric motors in which the rotor carries the coils. The invention also applies equally to electric generators. Although the present embodiment describes an electric motor having a stator and rotor, where the stator and rotor have a circumferential support, the invention is equally applicable to electric motors having stators and rotors with a different configuration, for example a linear electric motor.

Accordingly, the term rotor is intended to cover the moving component of an electric motor irrespective of the shape of that component and as such is intended to cover a forcer in a linear electric motor.

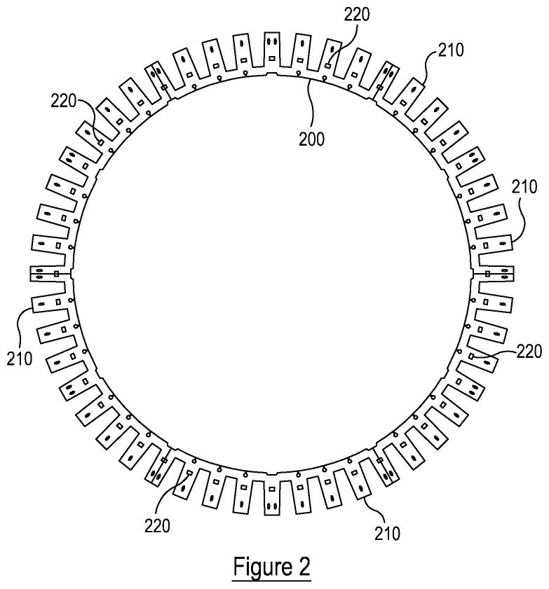

In accordance with a first embodiment of the invention, FIG. 2 illustrates a circumferential support 200.

Distributed about the outer circumference of the circumferential support 200, that is to say stator back-iron, are a plurality of teeth 210 that extend in a radial direction. The plurality of teeth 210 extend outwardly away from the outer surface of the stator back-iron 200.

The stator back-iron 200, including the teeth 210, are formed as a single piece, integral, structural component. For example, the stator back-iron 200 can be moulded from powder metal, or more commonly, built up of a number of identical laminations, where the laminations will typically be manufactured from sheets of steel, such as electrical steel, however any material with appropriate strength and electromagnetic properties can be used. The laminations may also have an insulating coating on the surface and along the curved interface shape between teeth stacks and stator back-ring (i.e. circumferential support 200) to prevent eddy currents from flowing between the laminations.

The laminations can be produced by any suitable means, for example stamping or cutting the desired shape from a sheet of the required material or laser etching. As an example, the laminations may have a thickness of between 0.1 and 0.5 mm and preferably around 0.35 mm.

Each of the teeth 210 formed on the stator back-iron 200 are arranged to receive a bobbin (as described below), where each of the teeth 210 and respective bobbin include engagement means to allow a bobbin to be mounted to a tooth 210 in a radial direction, as described below.

For the purposes of the present embodiment, the preferred means for allowing a bobbin to be attached to a tooth includes a cut away section 220 formed on a front and back face of each of the stator teeth 210, where each of the cut away sections are arranged to receive an engagement element formed on a bobbin for retaining the bobbin to a stator tooth, as described below. However, any suitable means may be used for attaching a bobbin to a stator tooth.

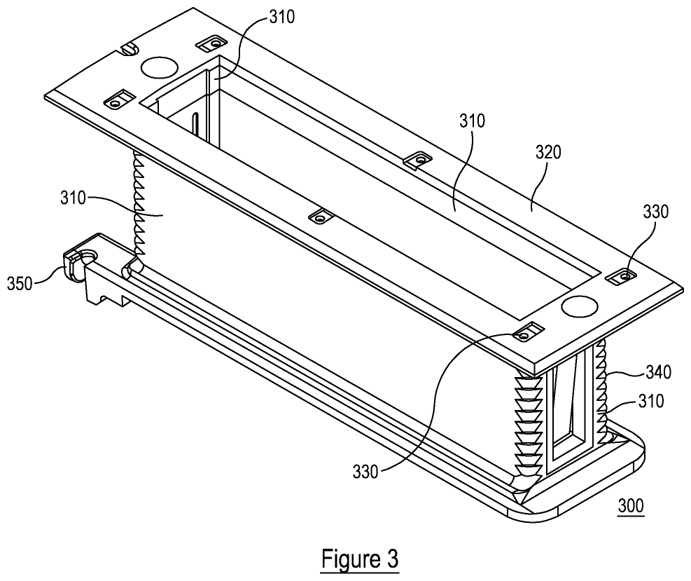

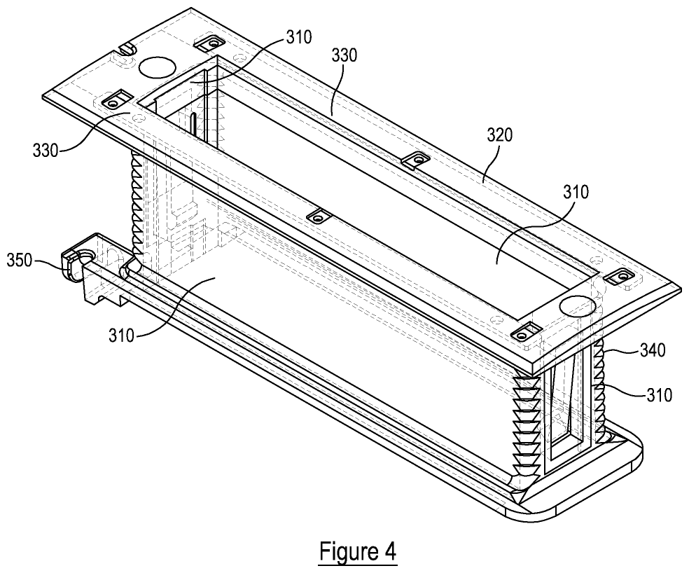

FIGS. 3 and 4 illustrate a bobbin 300, according to an embodiment of the present invention, for mounting to the stator back-iron 200 illustrated in FIG. 2. FIG. 3 illustrates a perspective view of a bobbin according to an embodiment of the present invention and FIG. 4 illustrates a transparent perspective view of a bobbin according to an embodiment of the present invention, where the same reference numerals in these Figures relate to the same features of the bobbin 300. Preferably, the bobbin 300 is manufactured using an injection moulded process where the bobbin 300 includes four wall sections 310 that forms a housing having a cuboid shape with an aperture formed in the centre of the bobbin 300. The aperture is sized to receive a stator tooth 210. The bobbin 300 is arranged to receive coil windings (not shown) formed around the four wall sections 310. To aid electrically isolation between the coil windings and a stator tooth 210, the bobbin 300 is formed from an insulating material. Preferably the insulating material will be a plastic having a good thermal conductivity, high temperature deflection and good dielectric strength, for example liquid crystal polymer.

To aid the retention of coil windings mounted on the bobbin 300, the top portion of the bobbin extends away from the respective bobbin wall sections 310 to form a flange 320, as described below. When the bobbin 300 is mounted to a stator tooth 210, the flange 320 forms a laterally extending stator tip for the respective stator teeth formed on the circumferential support. Although the present embodiment illustrates the flange 320 extending around the whole perimeter formed by the four wall sections 310, the flange 320 may include cut away sections, for example at the end sections of the bobbin 300.

Formed on or in each of the longitudinal flange sections is a metal strip 330. Preferable the metal used is electrical steel. For example, the metal strips 330 may be formed on an upper surface of a respective flange section 320, a lower surface of a respective flange section 320 or in a respective flange section 320. For the purposes of the present embodiment, as illustrated in FIGS. 3 and 4, a metal strip 330 is formed within each of the longitudinal flange sections 320.

To aid the location of the metal strips within the longitudinal flange sections 320 during the injection moulding process, preferably the metal strips are held in place using a positioning tool (not shown), which results in apertures 330 being formed in the upper surface of the flange 320. Preferably support is also provided to the respective metal strips during the injection moulding process to prevent the metal strips becoming bent/distorted from the high flow pressure used. This may result in further apertures (not shown) being formed in the upper surface of the flange 320.

To allow a bobbin 300 to be attached to a stator tooth 210, as mentioned above, each stator tooth 210 includes at least one cut away section 220 on at least one side of the stator tooth 210, which forms a recess. A sprung loaded engagement element 340 is formed on the forward and/or back faces of the bobbin housing. Although the present embodiment describes the use of two engagement elements 340 on two sides of the bobbin housing, a single engagement element may be used. The engagement elements 340 are arranged to engage with the cut away sections formed on the stator tooth 210 to allow the bobbin 300 and the stator tooth 210 to become interlocked, thereby preventing the removal of the bobbin 300 from the stator tooth 210.

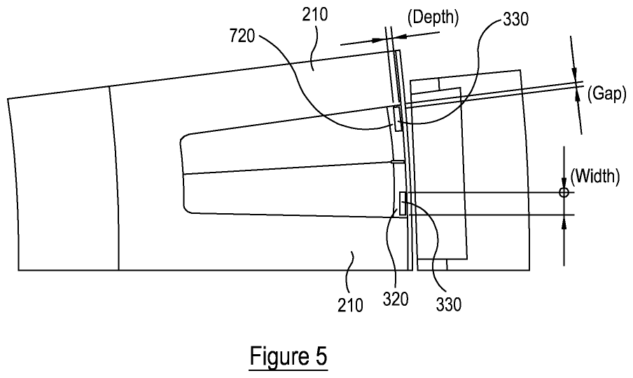

Different electric motor characteristics may be derived by varying the gap between the stator tooth 210 and the inner edge of the metal strip 330, the width of the metal strip 330 and the depth of the metal strip 330, where the dimension of the respective metal strips are selected based on the required electric motor characteristics, where FIG. 5 illustrates the different dimensions of a metal strip 330 with respect to a stator tooth 210.

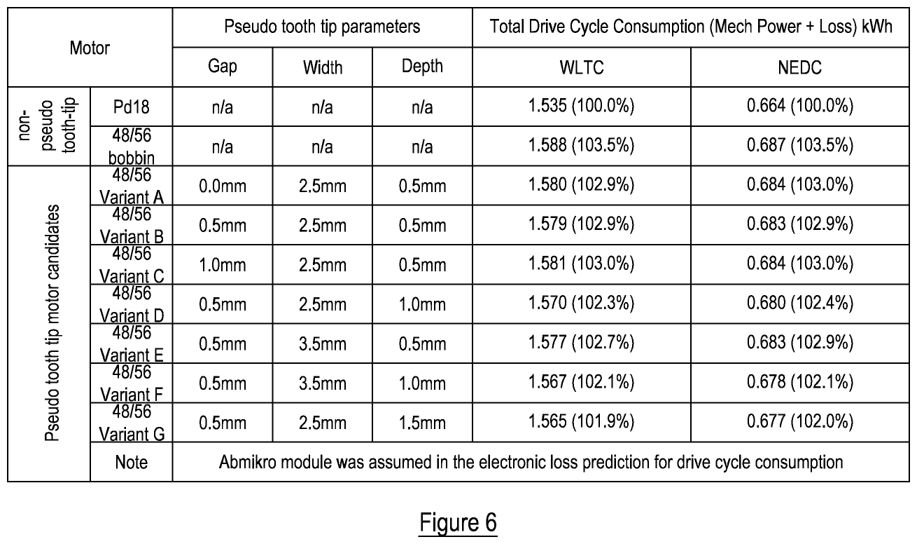

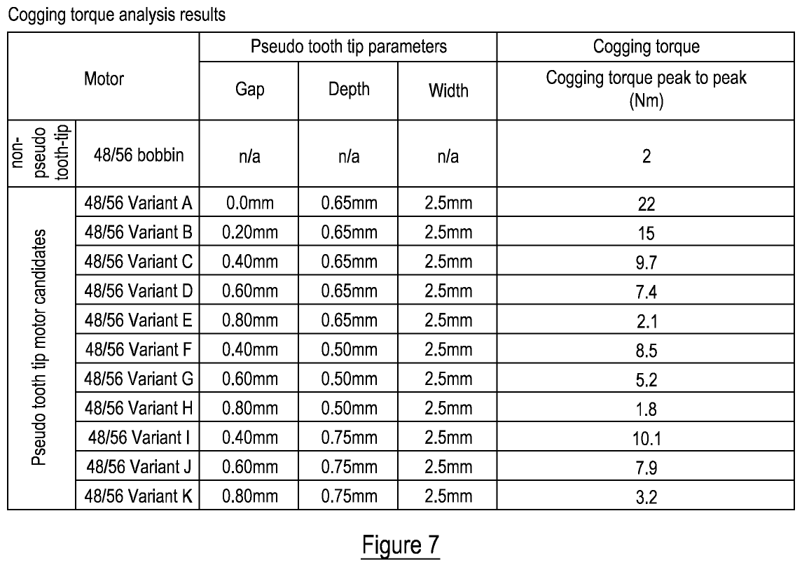

For example, FIG. 6 illustrates examples of different drive cycle consumption values for different metal strip gap, width and depth values, while FIG. 7 illustrate examples of different cogging torque results for different metal strip gap, width and depth values.

Preferably, in addition to the use of the flange 320, the bobbin 300 includes additional features that aid the retention of the coil windings on the bobbin, for example ridges 340 are formed at the corner of the housing to facilitate positioning of the coil windings on the bobbin 300.

As also illustrated in FIGS. 3 and 4, preferably the bobbin 300 includes a mounting point 350 for lead routing of the coil winding mounted on the bobbin to a power board (not shown), where a power board is arranged to control the current to coil windings.

As mentioned above, as each bobbin 300 is separate from a stator tooth 210, each bobbin 300 can be pre-wound with coil windings before the bobbin 300 is mounted to a stator tooth 210 with the advantage that the winding of coils on the bobbin 300 is easier than if the coil windings are mounted directly to the stator. For example, the slot fill (i.e. the amount of copper wire that fills the slots between stator teeth) for conventional electric motor designs will be of the order of 37%. However, by allow winding of coils to be applied to a stator tooth without the space constraints imposed when the stator is formed as a single piece with integral teeth the slot fill can be increase to approximately 54% or more.

To mount each bobbin 300 to a respective stator tooth 210 the bobbins 300 are radially pressing onto a respective stator tooth 210 formed on the stator back-iron 200. Sufficient radial force is applied to a stator tooth 300 to force the bobbin downward to allow the engagement elements 340 to interlock with the cut away sections 220 formed on a stator tooth 210.

In other words, when a bobbin 300 is to be mounted to a stator tooth 210 the bobbin 300 is positioned over a stator tooth 210 and radially pressed against the stator tooth 210.

Preferably, an adhesive is applied to one or more surfaces on a bobbin 300 and/or a stator tooth 210, which abut when the bobbin 300 is mounted to the stator tooth 210. For example, using either impregnation varnish or potting encapsulation. The application of an adhesive to one or more surfaces of the bobbin 300 and/or stator tooth 210 helps to minimise micro-movement of the bobbin 300 and local vibration of the bobbin 300 relative to the stator tooth 210. To aid thermal conductivity between the bobbin 300 and the stator tooth 200 the adhesive is preferably selected to have a good thermal conductivity. The adhesive can also help to electrically isolate the bobbin 300 from the stator tooth 210.

For the purposes of the present embodiment, a fully assembled stator includes 48 stator teeth, however any number of teeth can be used, where preferably the number is between 6 and 100.

It will be appreciated that whilst the invention as shown in the figures and substantially as described relates to an arrangement in which the rotor surrounds a stator and rotates around it, it is fully within the scope of the current invention for the stator to surround the rotor with the winding teeth protruding radially inwards towards the centre of the stator rather than radially outwards.

Also, whilst the invention has been described in relation to stators for electric motors, the invention is equally applicable to elements of an electric generator.

Although stators embodying the present invention can be of any size, preferred sizes will depend upon the desired size of the electric motor or generator. For example, for an electric motor having an 18″ diameter, the outside radius of the stator may be around 191 mm (i.e. that stator diameter is 382 mm). For a 20″ diameter motor the outside diameter of the stator may be around 424 mm and for a 14″ diameter motor the outside diameter may be around 339 mm.

A stator constructed according to the above embodiment finds particular utility in electric motors for electric vehicles. In particular, embodiments of the invention may be incorporated into road going electric vehicles and more—14—specifically electric vehicles having one or more in-wheel electric motors.

1. A bobbin for a stator or rotor of an electric motor, the bobbin comprising:
an injection moulded plastic housing having a first section and a second section, wherein the first section is arranged to receive coil windings and includes an aperture to allow a tooth mounted on the stator or rotor to extend through the aperture, wherein the second section includes a flange arranged to extend in a first direction substantially orthogonal to the aperture that acts as a tooth tip for the tooth, wherein a metal element is mounted in or on the flange.

2. The bobbin according to claim 1, wherein the metal element is electrically isolated from the tooth.

3. The bobbin according to claim 1, wherein the metal element is electrically coupled to the tooth.

4. The bobbin according to claim 1, wherein the aperture is formed in a rectangular face of the first section.

5. The bobbin according to claim 4, wherein the flange is formed on a first side of the rectangular face of the first section and a second side of the rectangular face of the first section.

6. The bobbin according to claim 1, wherein the injection moulded plastic housing includes a coupling for retaining the injection moulded plastic housing to the tooth.

7. The bobbin according to claim 6, wherein the coupling includes a first sprung loaded latch formed on a third side of the rectangular face of the first section, wherein the first sprung loaded latch is arranged to engage with a first coupling arrangement on the tooth.

8. The bobbin according to claim 7, wherein the coupling includes a second sprung loaded latch formed on a fourth side of the rectangular face of the first section, wherein the second sprung loaded latch is arranged to engage with a second coupling arrangement on the tooth.

9. A stator comprising:
a circumferential support having a plurality of stator teeth, wherein a bobbin is mounted upon one or more of the plurality of stator teeth, and
wherein the bobbin comprises an injection moulded plastic housing having a first section and a second section, wherein the first section is arranged to receive coil windings and includes an aperture to allow a tooth mounted on the stator or rotor to extend through the aperture, wherein the second section includes a flange arranged to extend in a first direction substantially orthogonal to the aperture that acts as a tooth tip for the tooth, wherein a metal element is mounted in or on the flange.

10. A rotor comprising:
a circumferential support having a plurality of rotor teeth, wherein a bobbin is mounted upon one or more of the plurality of rotor teeth, and
wherein the bobbin comprises an injection moulded plastic housing having a first section and a second section, wherein the first section is arranged to receive coil windings and includes an aperture to allow a tooth mounted on the stator or rotor to extend through the aperture, wherein the second section includes a flange arranged to extend in a first direction substantially orthogonal to the aperture that acts as a tooth tip for the tooth, wherein a metal element is mounted in or on the flange.

11. A method for mounting a bobbin, wherein the bobbin comprises an injection moulded plastic housing having a first section and a second section, wherein the first section is arranged to receive coil windings and includes an aperture to allow a tooth mounted on the stator or rotor to extend through the aperture, wherein the second section includes a flange arranged to extend in a first direction substantially orthogonal to the aperture that acts as a tooth tip for the tooth, wherein a metal element is mounted in or on the flange, the method comprising:
mounting the bobbin on the tooth formed on a circumferential support.
